(19) United States
(12) Patent Application Publication
(10) Pub. No.: US 2009/0049087 A1
(43) Pub. Date: Feb. 19, 2009

(54) Methods, systems, and computer program products for providing a universal uniform resource identifier (UURI)

(75) Inventors: David Cackowski, Chapel Hill, NC (US); Peter J. Marsico, Chapel Hill, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Tekelec

(21) Appl. No.: 11/893,992

(22) Filed: Aug. 17, 2007

(51) Int. Cl. G06F 17/30

(52) U.S. Cl. 707/103 X; 707/E17.055

(57) ABSTRACT

Methods, systems, and computer program products for providing a universal uniform resource identifier (UURI) are disclosed. According to one aspect, the subject matter described herein includes a method for mapping a universal uniform resource identifier (UURI) to a uniform resource identifier (URI). The method includes receiving a message containing a UURI associated with a subscriber and containing a media type indicator indicating a media type; identifying a URI based on the UURI and media type indicator; and sending a message containing the identified URI.

### RELATED APPLICATIONS

This application claims the benefit of U.S. Provisional patent application Ser. No. (not yet assigned), filed Aug. 10, 2007, entitled “Methods, Systems, and Computer Program Products for Providing a Universal Uniform Resource Identifier (UURI),” the disclosure of which is incorporated herein by reference in its entirety.

### TECHNICAL FIELD

The subject matter described herein relates to methods and systems for providing uniform resource identifier mapping in a communications network. More particularly, the subject matter described herein relates to methods, systems, and computer program products for providing a universal uniform resource identifier (UURI).

### BACKGROUND

With the increase in the popularity, use, and capabilities of computers, computer networks, the Internet, telephone networks and telecommunications systems, users of these systems and networks are identified by and contacted via an ever-increasing number of identifiers. A user must typically maintain and/or remember home phone numbers, cell phone numbers, email addresses, instant messaging addresses, home web pages, and the like, not only for the user but also for family, friends, social and business acquaintances, etc. In addition, as the various networks and systems merge and converge, users desire to communicate in ways that transcend the historical and technological distinctions between networks.

For example, an Internet protocol (IP) multimedia subsystem (IMS) network is defined by the Third Generation Partnership Project (3GPP) as a new mobile network infrastructure that enables the convergence of data, speech, and mobile network technology over an IP-based infrastructure. IMS bridges the gap between the existing traditional telecommunications technology and Internet technology, allowing network operators to offer a standardized, reusable platform that can be used to provide services for both mobile networks and landline networks at the same time, providing unique mixtures of services with transparency to the end user.

The main function of IMS is to set up media communication sessions between users and between users and applications. IMS uses the session initiation protocol (SIP) for initiating, modifying, and terminating an interactive user session that involves multimedia elements, such as video, voice, instant messaging, online games, and virtual reality, and provides the service creator the ability to combine services in the same session and dynamically modify sessions “on the fly” (e.g., adding a video component to an existing voice session). As a result, new and innovative user-to-user and multi-user services become available, such as enhanced voice services, video telephony, chat, push-to-talk, and multimedia conferencing, all of which are based on the concept of a multimedia session. Thus, for example, an IMS subscriber may want to send an email to a cell phone or place a telephone call using a computer—just two examples of the blurring of the lines between the formerly distinct and incompatible telephone and computer networks.

Even with merged networks, however, there are still some disadvantages and inconveniences, which are holdovers from a time when telephone and computer networks were separate entities. One such disadvantage is the continued need to maintain multiple pieces of contact information (e.g., telephone number, cell phone number, email address, instant message address, etc.) for each person in a subscriber's contact list. For example, subscriber A cannot send an email to subscriber B, unless A knows B's email address. In other words, even if A knows all of B's other contact information, such as telephone number, cell phone number, instant message address, etc., A will be unable to send an email to B.

Consider the situation where subscriber B uses a mobile phone which can receive email: from a networking standpoint, both a voice call and an email will reach the same destination—subscriber B's mobile phone—and may even travel the same path through the network to reach the same destination. Under the conditions existing today, A can call B (because A knows B's telephone number) but A cannot send an email to B (because A does not know B's email address), even though the destination of the message is the same.

Accordingly, in light of the disadvantages described above, there exists a need for a subscriber on an integrated network, such as a session initiation protocol (SIP) network, a next generation network (NGN), or an IMS network, to be able to provide other subscribers with a single, easy to remember URI identifier which may be used to facilitate any mode of communication with the IMS subscriber (e.g., voice, email, messaging, multimedia, etc.). Specifically, there exists a need for a system and method for allowing a universal uniform resource indicator (URI), or UURI, to be associated with a subscriber, such that all communications may be addressed to the UURI regardless of the communication mode.

### SUMMARY

According to one aspect, the subject matter described herein includes a method for mapping a universal uniform resource identifier (UURI) to a uniform resource identifier (URI). The method includes receiving a message containing a UURI associated with a subscriber and containing a media type indicator indicating a media type; identifying a URI based on the UURI and media type indicator; and sending a message containing the identified URI.

According to another aspect, the subject matter described herein includes a system for mapping a universal uniform resource identifier (UURI) to a uniform resource identifier (URI). The system includes a UURI resolution database (URDB) for associating a UURI and media type tuple with a subscriber URI. The system also includes a UURI resolution function (URF) for receiving a message containing a UURI associated with a subscriber and containing a media type indicator indicating a media type. The URF identifies, using the URDB, a URI based on the UURI and media type indicator, and sends a message containing the identified URI.

The subject matter described herein for providing a universal uniform resource identifier (UURI) may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer program product comprising computer executable instructions embodied in a computer readable medium. Exemplary computer readable media suitable for implementing the subject matter described herein include disk memory devices, chip memory devices, programmable logic devices, application specific integrated circuits, and downloadable electrical signals. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a flow chart illustrating an exemplary method for mapping a universal uniform resource identifier (UURI) to a uniform resource identifier (URI) in accordance with an embodiment of the subject matter described herein;

FIG. 2 is a block diagram illustrating an exemplary system for mapping a universal uniform resource identifier (UURI) to a uniform resource identifier (URI) via explicit query/response transaction in accordance with an embodiment of the subject matter described herein;

FIG. 3 is a block diagram illustrating an exemplary system for mapping a universal uniform resource identifier (UURI) to a uniform resource identifier (URI) via message relay in accordance with another embodiment of the subject matter described herein;

FIG. 4 is a block diagram illustrating an exemplary system for mapping a universal uniform resource identifier (UURI) to a uniform resource identifier (URI) with PRESENCE qualification, and the system's response when the subscriber is present, in accordance with yet another embodiment of the subject matter described herein; and

FIG. 5 is a block diagram illustrating an exemplary system for mapping a universal uniform resource identifier (UURI) to a uniform resource identifier (URI) with PRESENCE qualification, and the system's response when the subscriber is not present, in accordance with yet another embodiment of the subject matter described herein.

### DETAILED DESCRIPTION

In accordance with the subject matter disclosed herein, systems, methods, and computer program products are provided for providing a universal uniform resource identifier (UURI). All communication, regardless of media type (data, call, message, media stream, video, audio, text, etc.), that is intended to be sent to a particular subscriber may be directed to a single UURI. The UURI is considered along with the media type in order to identify an appropriate uniform resource identifier (URI) to which the message, data, call, and/or media stream, etc., should be directed.

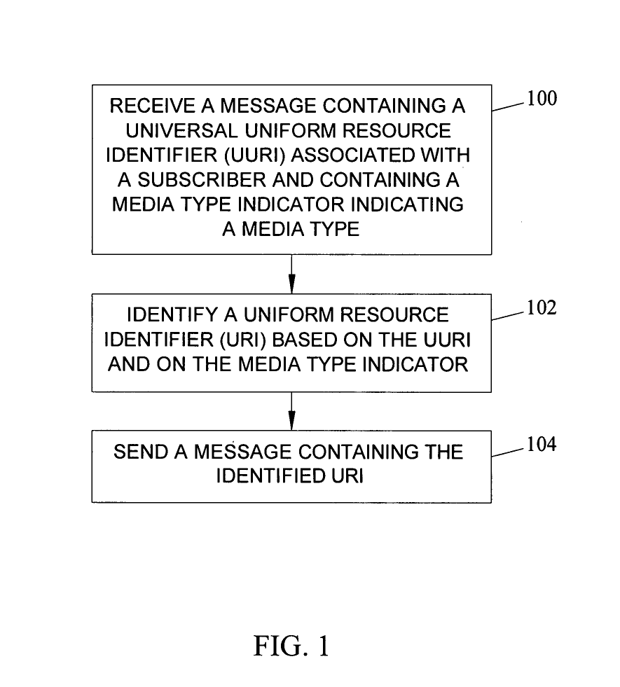

FIG. 1 is a flow chart illustrating an exemplary method for mapping a universal uniform resource identifier (UURI) to a uniform resource identifier (URI) in accordance with an embodiment of the subject matter described herein.

In block 100, a message is received containing a UURI associated with a subscriber and also containing a media type indicator indicating a media type. For example, in an Internet protocol multimedia subsystem (IMS) network, a session initiation protocol (SIP) message, such as a SIP INVITE message, may be received from a subscriber who is attempting to place a voice over IP (VOIP) call. Table 1, below, displays an example SIP message format.

TABLE 1
Example SIP Message Format

| | |
|---|---|
| Start Line | Method • Request-URI • SIP Version |
| General | To: |
| Headers | From: |
| | Call-ID: |
| | CSeq: |
| | Max Forwards: |
| | Expires: |
| | Date: |
| | Supported: |
| | Require: |
| | Content-Type: |
| | Content-Length: |

Blank Line

| | |
|---|---|
| Message Body | Media Negotiation \| SDP \| MIME \| . . . |

There are several places within a SIP message that could include a UURI. For example, a UURI associated with a subscriber may be included in the SIP start line “Request URI” field, the SIP general header “To:” field, and/or the SIP general header “From:” field.

There are several places within a SIP message that could include a media type. For example, a media type indicator may be included in the SIP general header “Content-Type” field. If the message body is in the multipurpose Internet mail extensions (MIME) format, the media type indicator may be found in the MIME “Content-Type:” header. For example, a MIME-encoded voice mail might have the MIME header “Content-Type: audio/mpeg”. If the message body is in the session description protocol (SDP) format, the media type indicator may be found in the SDP media description section. For example, a video stream might have the SDP media descriptor “m=video”.

The examples above are not intended to be an exhaustive list of the possible locations for UURIs or media types; a UURI and/or media type could be included in other parts of a SIP message, or in other types of messages.

In block 102, a URI is identified based on the UURI associated with a subscriber and on the media type indicator. In one embodiment, a table such as Table 2, shown below, may be used to map a UURI and media type to a URI in accordance with an embodiment of the subject matter described herein.

TABLE 2
UURI Resolution Function Table

| UURI | Media Type | Resolved to URI |
|---|---|---|
| user@Tekelec.com | Image | sip: userPic@vzw.com |
| user@Tekelec.com | Text | sip: userIM@vzw.com |
| user@Tekelec.com | Video | sip: userMovie@vzw.com |
| user@Tekelec.com | Message | mailto: userSMS@vzw.com |
| user@Tekelec.com | Audio | sip: userVOIP@vzw.com |
| user@Tekelec.com | Audio | tel: 9194605555 |

In block 104, a message is sent containing the identified URI. Referring to Table 2, above, it can be seen that the UURI “user@Tekelec.com” may be resolved to a variety of different URIs depending on the media type.

In one example, a text message, such as a short message service (SMS) message, is sent to “user@Tekelec.com”. The UURI would be resolved to “sip:userIM@vzw.com”, and the SMS message would be sent to User's instant message (IM) service at “userIM@vzw.com”.

In another example, a picture is sent to “user@Tekelec.com”. The UURI would be resolved to “sip:userPic@vzw.com”, and the image data would be sent for example to User's handheld personal digital assistant.

The last row in Table 2 might be used as the default or fallback case, to be used for example if the media type included in the message doesn't match any entry in Table 2, or when a URI in the table doesn't respond, as might be the situation if User's VOIP connection is off line, in which case the audio message should be sent to User's regular telephone or voicemail account.

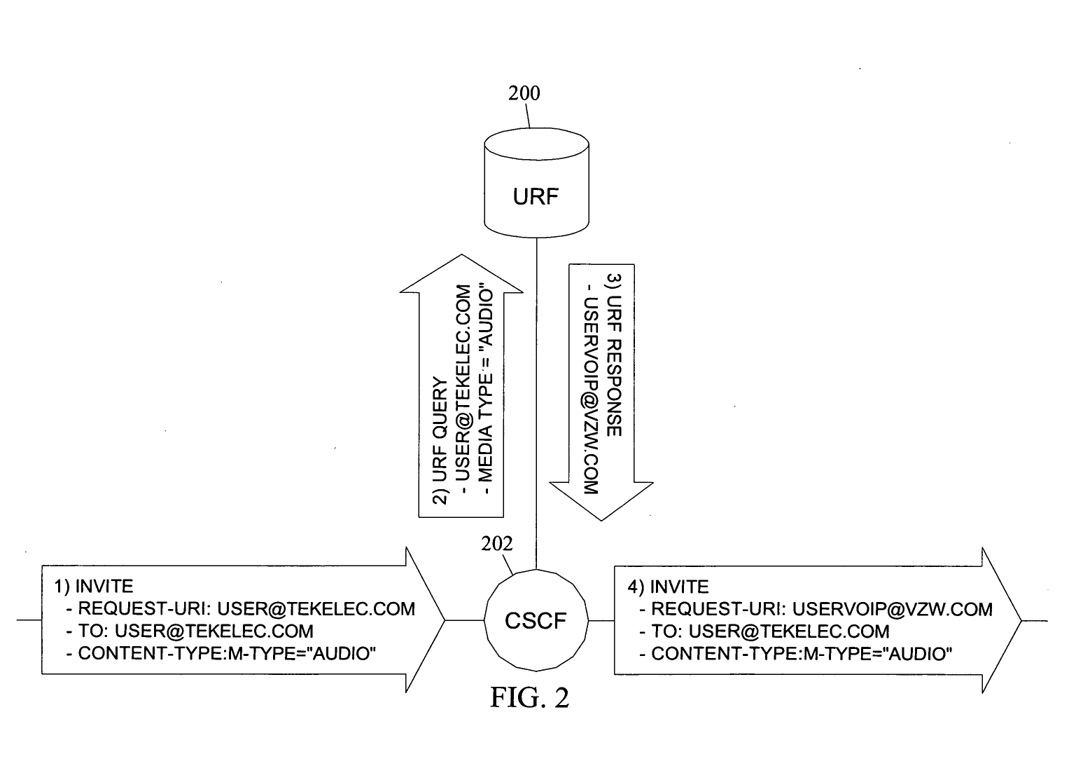

FIG. 2 is a block diagram illustrating an exemplary system for mapping a universal uniform resource identifier (UURI) to a uniform resource identifier (URI) in accordance with an embodiment of the subject matter described herein. Referring to FIG. 2, the system may include a universal URI resolution function URF 200 for resolving a universal uniform resource identifier (UURI) associated with a subscriber and containing a media type indicator indicating a media type. URF 200 may identify a uniform resource indicator (URI) based on the UURI and media type indicator, and send a message containing the identified URI.

For example, a call session control function CSCF 202 may receive a message, such as a SIP INVITE message (FIG. 2, message 1). The message may include a UURI. For example, the UURI may be part of the SIP “Request-URI:” field or the SIP “To:” field. The SIP message may also include a media type indicator, such as the SIP “Content-Type:” field. In Message 1, both the Request-URI: and To: fields contain the same UURI, “user@Tekelec.com”, and the Content-Type: field contains the string ‘m-type=“audio”’, indicating that the media type is an audio stream.

In one embodiment, shown in FIG. 2, CSCF 202 may send a query to URF 200 and receive a response from URF 200. For example, upon receiving the SIP invitation (FIG. 2, message 1), CSCF 202 may detect that the incoming message includes a UURI (in the Request-URI: field) and a media type indicator (in the Content-Type: field) and send to URF 200 a URF query message containing a UURI associated with a subscriber and also containing a media type indicator indicating a media type. (FIG. 2, message 2). Upon receipt of the message URF 200 may resolve the UURI to the appropriate URI based on the media type. In one embodiment, URF 200 may perform a table lookup using a table such as Table 2, above. URF 200 may send a response message containing the URI associated with the subscriber and the media type indicator (FIG. 2, message 3) back to CSCF 202. CSCF 202 may then replace the UURI in the original message with the URI returned by URF 200 and send the message containing the identified URI to the message's destination (FIG. 2, message 4). In this embodiment, URF 200 performs a query/response function: URF 200 receives a query message from a querying entity, such as CSCF 202, performs the UURI resolution function, and sends a response message containing the identified URI back to the querying entity.

In another embodiment, CSCF 202 may not be adapted to or may be unable to detect the presence of a UURI in the received SIP INVITE message (FIG. 2, message 1), and may by default initiate an associated URF query transaction (similar to that described above).

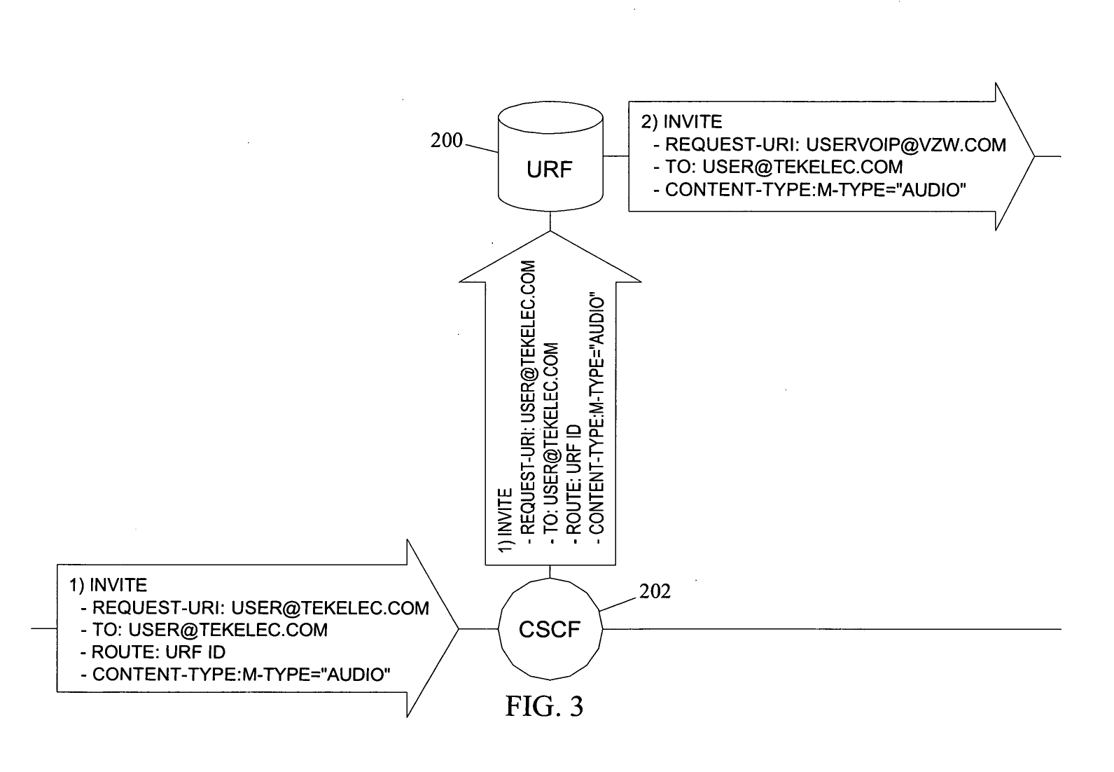

FIG. 3 is a block diagram illustrating an exemplary system for mapping a universal uniform resource identifier (UURI) to a uniform resource identifier (URI) in accordance with another embodiment of the subject matter described herein. In this embodiment, when CSCF 202 receives a message containing a UURI and media type indicator, such as a SIP INVITE message (FIG. 3, message 1), CSCF 202 may forward the message to URF 200 (FIG. 3, message 2). Upon receipt of the message containing a UURI associated with a subscriber and also containing a media type indicator indicating a media type, URF 200 may identify a URI based on the UURI associated with the subscriber and on the media type indicator and then send a message containing the identified URI to the message's destination (FIG. 3, message 3). In this embodiment, URF 200 performs a message receive/modify/forward function: URF 200 receives a message from a source entity, such as CSCF 202, performs the UURI resolution function, and sends a message containing the identified URI to a destination entity that is different from the source entity. The message sent to the destination entity may be an entirely new message, or it may be identical to the received message but with the UURI replaced by the identified URI. In this manner, network traffic is reduced when compared to the embodiment shown in FIG. 2.

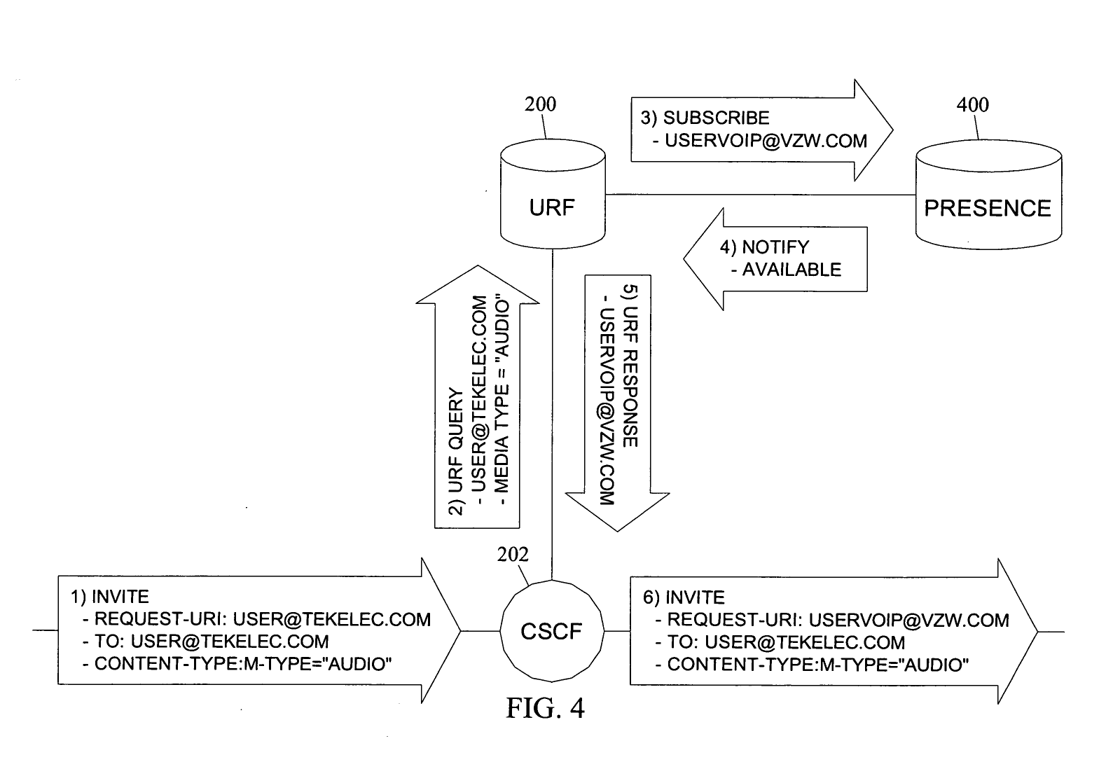

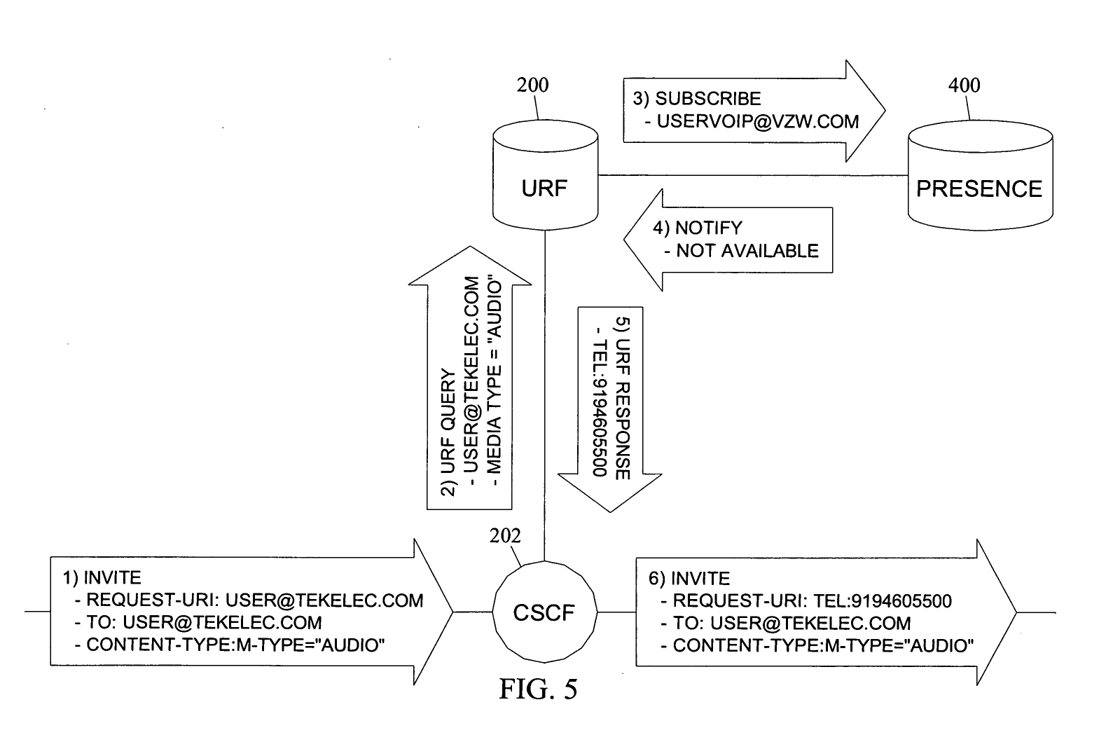

FIGS. 4 and 5 illustrate a block diagram of an exemplary system for mapping a universal uniform resource identifier (UURI) to a uniform resource identifier (URI) operating in conjunction with a presence function for determining the on-line availability of a subscriber associated with the UURI in accordance with yet another embodiment of the subject matter described herein. FIG. 4 illustrates an exemplary behavior of the system when the subscriber associated with the UURI is available, while FIG. 5 illustrates an exemplary behavior of the system when the subscriber associated with the UURI is not available. For the purposes of illustration, the subscriber in this example is assumed to have two types of telephone: a VOIP phone, which is connected to the Internet, and another phone connected to a traditional telephone network such as a PSTN network. It is also assumed that the subscriber prefers to receive voice calls on her VOIP phone if she is currently on-line (i.e., connected to the Internet) and on her other phone if she is not currently on-line.

FIG. 4 illustrates an exemplary behavior of the system when the subscriber associated with the UURI is available. In FIG. 4, a message containing a UURI associated with a subscriber and also containing a media type indicator indicating a media type, such as a SIP INVITE message (FIG. 4, message 1) is received by CSCF 202. In this example, the SIP invitation specifies that the content type is “audio”, indicating that the invitation is to create a voice session or voice call.

As in the case of FIG. 2, message 2, described above, CSCF 202 may send a UURI resolution function query (FIG. 4, message 2) to URF 200. Referring again to Table 2, above, it can be seen that the UURI “user@Tekelec.com” has two URIs associated with the media type “Audio”: the first is “sip:userVOIP@vzw.com”, used for VOIP calls, and the second is “tel:9194605500”, used for traditional telephone calls. URF 200 may first resolve the UURI and media type and determine that the URI “userVOIP@vzw.com” should be used.

URF 200 may then determine the presence status of the subscriber associated with the URI. For example, URF 200 may issue a message, such as a subscribe request (FIG. 4, message 3), to a presence function 400. Presence function 400 may return a message indicating the current status of the subscriber associated with the URI (FIG. 4, message 4).

In FIG. 4, the subscriber is available; in this case, URF 200 may respond to the URF query with a message containing the subscriber's VOIP URI (FIG. 4, message 5). CSCF 202 may then replace the UURI in the original message with the VOIP URI, and issue the modified message to the message's destination (FIG. 4, message 6).

FIG. 5 illustrates an exemplary behavior of the system when the subscriber associated with the UURI is not available. In FIG. 5, the operation and response of the system to the first three messages are identical to the example described in FIG. 4; that explanation will not be duplicated here.

In FIG. 5, however, presence function 400 returns a message indicating that the subscriber associated with the URI is not available (FIG. 5, message 4).

In response to determining that the subscriber is not available, URF 200 may determine that an alternate, fallback, or default URI is available for the specified media type. For example, referring again to Table 2, above, URF 200 may resolve the UURI and media type to the URI “tel:9194605500”, and respond to the URF query with a message containing the subscriber's PSTN or mobile telephone number (FIG. 5, message 5).

CSCF 202 may then replace the UURI in the original message with the subscriber's telephone number, and issue the modified message to the message's destination (FIG. 5, message 6).

In alternative embodiments, the functions performed by CSCF 202 as described above and in FIGS. 2 through 6 may be performed by another network element or another type of network element, such as a SIP router, a SIP proxy, or other SIP node, for example.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for providing a universal uniform resource identifier (UURI), the method comprising:
(a) receiving a message containing a UURI associated with a subscriber and containing a media type indicator indicating a media type;
(b) identifying a uniform resource identifier (URI) based on the UURI and the media type indicator; and
(c) sending a message containing the identified URI.

2. The method of claim 1 wherein receiving the message containing the UURI and the media type indicator comprises receiving a message from a call session control function (CSCF).

3. The method of claim 1 wherein receiving the message containing the UURI and the media type indicator comprises receiving a message from a session initiation protocol (SIP) router.

4. The method of claim 1 wherein the message containing the UURI and the media type indicator is received from a first network entity and wherein the message containing the identified URI is sent to the first network entity.

5. The method of claim 4 wherein the message containing the UURI and the media type indicator comprises a UURI resolution function (URF) query message and the message containing the identified URI comprises a URF response message.

6. The method of claim 1 wherein the media type indicator indicates a media type of at least one of a data type, a call type, a message type, a media stream type, a video type, an audio type, and a text type.

7. The method of claim 1 wherein the message containing the UURI and the media type indicator is received from a first network entity and wherein the message containing the identified URI is sent to a second network entity.

8. The method of claim 7 wherein the message containing the UURI and the media type indicator comprises a first session initiation protocol (SIP) message and wherein the message containing the identified URI comprises a second SIP message.

9. The method of claim 8 wherein the first and second SIP messages comprise SIP INVITE messages.

10. The method of claim 1 wherein identifying a URI based on the UURI and the media type indicator includes identifying a first URI, determining a presence status associated with the first URI, and in response to determining that the presence status indicates that the subscriber is not available via the first URI, identifying a second URI associated with the subscriber.

11. The method of claim 1 wherein identifying a URI based on the UURI and the media type indicator includes using a UURI resolution database (URDB) for associating a UURI and media type tuple to a subscriber URI.

12. The method of claim 11 wherein the URDB comprises a relational database having records containing information identifying a UURI, a media type, and a subscriber URI.

13. The method of claim 11 wherein the URDB associates a UURI, media type, and presence status tuple to a subscriber URI.

14. The method of claim 13 wherein the URDB comprises a relational database having records containing information identifying a UURI, a media type, a presence status, and a subscriber URI.

15. The method of claim 1 wherein the UURI is associated with a plurality of different media-type-specific URIs for contacting the subscriber over different types of communication media.

16. The method of claim 1 wherein the identified UURI comprises a URI for contacting the subscriber via an Internet protocol multimedia subsystem (IMS) network.

17. The method of claim 1 wherein receiving the message containing the UURI and sending the message containing the identified URI comprise sending and receiving the messages using at least one of a network that uses a session initiation protocol (SIP), a network that uses a next generation network (NGN) protocol, and a network that uses an Internet protocol multimedia subsystem (IMS) protocol.

18. A system for providing a universal uniform resource identifier (UURI), the system comprising:
(a) a UURI resolution database (URDB) for associating a UURI and media type tuple with a subscriber uniform resource identifier (URI); and
(b) a UURI resolution function (URF) for:
(i) receiving a message containing a UURI associated with a subscriber and containing a media type indicator indicating a media type;
(ii) identifying, using the URDB, a uniform resource identifier (URI) based on the UURI and the media type indicator; and
(iii) sending a message containing the identified URI.

19. The system of claim 18 wherein the URF is adapted to receive the containing the UURI and the media type indicator from a call session control function (CSCF).

20. The system of claim 18 wherein the URF is adapted to receive the containing the UURI and the media type indicator from a session initiation protocol (SIP) router.

21. The system of claim 18 wherein the message containing the UURI and the media type indicator is received from a first network entity and wherein the message containing the identified URI is sent to the first network entity.

22. The system of claim 21 wherein the message containing the UURI and the media type indicator comprises a UURI resolution function (URF) query message and the message containing the identified URI comprises a URF response message.

23. The system of claim 18 wherein the media type indicator indicates a media type of at least one of a data type, a call type, a message type, a media stream type, a video type, an audio type, and a text type.

24. The system of claim 18 wherein the message containing the UURI and the media type indicator is received from a first network entity and wherein the message containing the identified URI is sent to a second network entity.

25. The system of claim 24 wherein the message containing the UURI and the media type indicator comprises a first session initiation protocol (SIP) message and wherein the message containing the identified URI comprises a second SIP message.

26. The system of claim 25 wherein the first and second SIP messages comprise SIP INVITE messages.

27. The system of claim 18 wherein the URF is adapted to identify a URI based on the UURI and the media type indicator by identifying a first URI, determining the presence status associated with the first URI, and in response to determining that the presence status indicates that the subscriber is not available via the first URI, identifying a second URI value associated with the subscriber.

28. The system of claim 18 wherein the URDB comprises a relational database having records containing information identifying a UURI, a media type, and a subscriber URI.

29. The system of claim 18 wherein the URDB associates a UURI, media type, and presence status tuple to a subscriber URI.

30. The system of claim 29 wherein the URDB comprises a relational database having records containing information identifying a UURI, a media type, a presence status, and a subscriber URI.

31. The system of claim 18 wherein the UURI is associated with a plurality of different media-type-specific URIs for contacting the subscriber over different types of communication media.

32. The system of claim 18 wherein the identified UURI comprises a URI for contacting the subscriber via an Internet protocol multimedia subsystem (IMS) network.

33. The system of claim 18 wherein the URF is adapted to receive the message containing the UURI and send the message containing the identified URI using at least one of a network that uses a session initiation protocol (SIP), a network that uses a next generation network (NGN) protocol, and a network that uses an Internet protocol multimedia subsystem (IMS) protocol.

34. A computer program product comprising computer executable instructions embodied in a computer readable medium for performing steps comprising:
(a) receiving a message containing a universal uniform resource identifier (UURI) associated with a subscriber and containing a media type indicator indicating a media type;
(b) identifying a uniform resource indicator (URI) based on the UURI and the media type indicator; and
(c) sending a message containing the identified URI.
